(19) United States
(12) Patent Application Publication
(10) Pub. No.: US 2025/0344705 A1
(43) Pub. Date: Nov. 13, 2025

(54) PIZZA MAKING APPARATUS AND FRANCHISE SYSTEM

(71) Applicant: Cookie Dough at Alpha Studio, Inc., Mill Valley, CA (US)

(72) Inventors: Curt von Badinski, Burbank, CA (US); Erin Patinkin, Hurley, NY (US); Maximillian Ventilla, Mill Valley, CA (US)

(73) Assignee: Cookie Dough at Alpha Studio, Inc., Mill Valley, CA (US)

(21) Appl. No.: 19/203,362

(22) Filed: May 9, 2025

Related U.S. Application Data
(60) Provisional application No. 63/644,870, filed on May 9, 2024.

(51) Int. Cl. A21B 3/00; A21C 9/04; A21C 9/08; G06Q 30/0282; G06Q 30/0601; G06Q 40/03

(52) U.S. Cl. CPC A21B 3/00; A21C 9/04; A21C 9/083; G06Q 30/0282; G06Q 30/0635; G06Q 40/03

(57) ABSTRACT

Pizza ingredient dispensing devices, pizza making apparatuses, and pizza franchise systems are disclosed. The pizza making devices can include computers and pizza ingredient dispensing devices or modules. Each pizza ingredient dispensing devices or module can have a compact design that allows an operator to quickly make high-quality customized pizzas in a relatively small physical space. The small footprint of the equipment allows a pizza franchise to occupy a relatively small kitchen area, which can reduce rent and other operating costs.

### CROSS-REFERENCE TO RELATED APPLICATIONS

The present application is a non-provisional application of and claims the benefit and priority under 35 U.S.C. § 119 (e) of U.S. Provisional Application No. 63/644,870, filed May 9, 2024, entitled “PIZZA MAKING APPARATUS AND FRANCHISE SYSTEM,” the entire content of which is incorporated herein by reference for all purposes.

### FIELD

Embodiments of the present disclosure generally relate to pizza ingredient dispensing devices, pizza making apparatuses, and pizza franchise systems.

### BACKGROUND

Pizzas are a popular food. A pizza normally includes a flat dough topped with tomato or other types of sauce, cheese, and other toppings. A pizza is placed in an oven or heating apparatus to bake the dough into a crust, melt the cheese, and cook the toppings. Franchised pizza restaurants can be very expensive to purchase and difficult to operate, requiring significant labor to run them. What is needed is a relatively small, automated pizza making apparatus that can be used within a physical space and an improved franchise system that can use server computers to process personalize orders and payments for consumers, and/or provide financing for franchisees through pizza sales.

### SUMMARY

One embodiment of the disclosure provides a pizza ingredient dispensing device for dispensing sauces and toppings on a pizza dough at varying weights. The pizza ingredient dispensing device comprises: a pizza tray movement stage configured to hold and move a pizza tray, the pizza tray for receiving and hold the pizza dough; a plurality of containers positioned above the pizza tray movement stage, each respective container comprising a storage compartment for storing a respective ingredient, and a valve for dispensing the respective ingredient through an outlet; a first motor mounted on a carriage; an actuator coupled to the first motor, the actuator configured to be engaged with the valve of each container, wherein the first motor is configured for actuating the actuator when the actuator is engaged with the valve of a respective container in order to dispense the respective ingredient; a second motor for moving the carriage so as to engage the actuator with the valve of a respective container; and a processor communicatively coupled with the pizza tray movement stage, the first motor, and the second motor. The processor is configured to: control the second motor so as to engage the actuator sequentially with the valves of one or more containers for selected ingredients according to a pizza order; control the first motor so as to dispense the selected ingredients from the one or more containers onto the pizza dough; and control the pizza tray movement stage to move the pizza tray in coordination with the controlling of the first motor and the second motor, so that the selected ingredients are dispensed evenly on the pizza dough.

Another embodiment of the disclosure provides a method of processing pizza orders through a computing server. The method includes: receiving a pizza order from a customer using a computing device via a communication network; receiving a payment from the customer via the communication network; forwarding the pizza order to a pizza franchise; forwarding the payment to a financial account of the pizza franchise; receiving pickup information from the pizza franchise; and forwarding the pickup information to the customer.

In some embodiments, the method further comprises: receiving customer feedback from the customer via the communication network; analyzing the customer feedback; and storing the customer feedback in a memory of the computing server.

In some embodiments, the method further comprises: receiving a first pizza order from the customer using the computing device via the communication network; determining that the customer is a repeat customer; offering a second pizza order to the customer via the communication network; receiving the second pizza order from the customer via the communication network; forwarding the second pizza order to a pizza franchise; receiving pickup information from the pizza franchise; and forwarding the pickup information to the customer.

Another embodiment of the disclosure provides a method for managing pizza franchises through a computing server. The method includes: receiving a statement from an applicant for opening a pizza franchise; determining whether to approve the statement; upon approving the statement, performing a credit check of the applicant; upon approving a loan for the applicant based on the credit check and receiving a down payment from the applicant, approving the applicant as a franchisee to open the pizza franchise; and distributing payments from customers of the franchisee to an owner of the loan, the franchisee, and a franchisor.

### BRIEF DESCRIPTION OF THE DRAWINGS

FIGS. 1A-1C show exploded views of a pizza ingredient dispensing device for dispensing sauces and toppings on a pizza dough according to some embodiments.

FIG. 2A illustrates a side view of a sealed container for storing and dispensing pizza ingredients according to some embodiments.

FIG. 2B illustrates a side view of an unsealed container for storing and dispensing pizza ingredients according to some embodiments.

FIG. 3 illustrates a side view of a container for storing and dispensing liquid ingredients according to some embodiments.

FIGS. 4A and 4B illustrate an ingredient dispensing process using a pizza ingredient dispensing device according to some embodiments.

FIG. 5 illustrates an ingredient dispensing process using a pizza ingredient dispensing device according to some embodiments.

FIGS. 6A-6B illustrate a pizza oven according to some embodiments.

FIG. 7 illustrates a robotic system for a pizza making apparatus according to some embodiments.

FIG. 8 illustrates a block diagram of a pizza franchise system according to some embodiments.

FIG. 9 is a flow diagram of method steps for processing pizza orders through a computing server according to some embodiments.

FIG. 10 is a flow diagram of method steps for processing pizza orders from repeat customers through a computing server according to some embodiments.

FIG. 11 is a flow diagram of method steps for managing pizza franchises through a computing server according to some embodiments.

FIG. 12 is a flow diagram of method steps for processing pizza orders through a computing server according to some embodiments.

FIG. 13 is a flow diagram of method steps for processing pizza orders from repeat customers via a computing server according to some embodiments.

FIG. 14 is a flow diagram of method steps for managing pizza franchises through a computing server according to some embodiments.

### DETAILED DESCRIPTION

The following detailed description is exemplary in nature and is not intended to limit the disclosure or the application and uses of the disclosure. Furthermore, there is no intention to be bound by any expressed or implied theory presented in the preceding technical field, background, summary, brief description of the drawings, or the following detailed description.

Embodiments of this disclosure provide pizza ingredient dispensing devices, pizza making apparatuses, and pizza franchise systems. The pizza making hardware can include computers and pizza ingredient dispensing devices or modules. Each pizza ingredient dispensing devices or module can have a compact design that allows an operator to quickly make high-quality customized pizzas in a relatively small physical space. The small footprint of the equipment allows a pizza franchise to occupy a relatively small kitchen area, which can reduce rent, allow for varying sizes of pizza restaurant, reduce need for staffing through automation, and other operating costs.

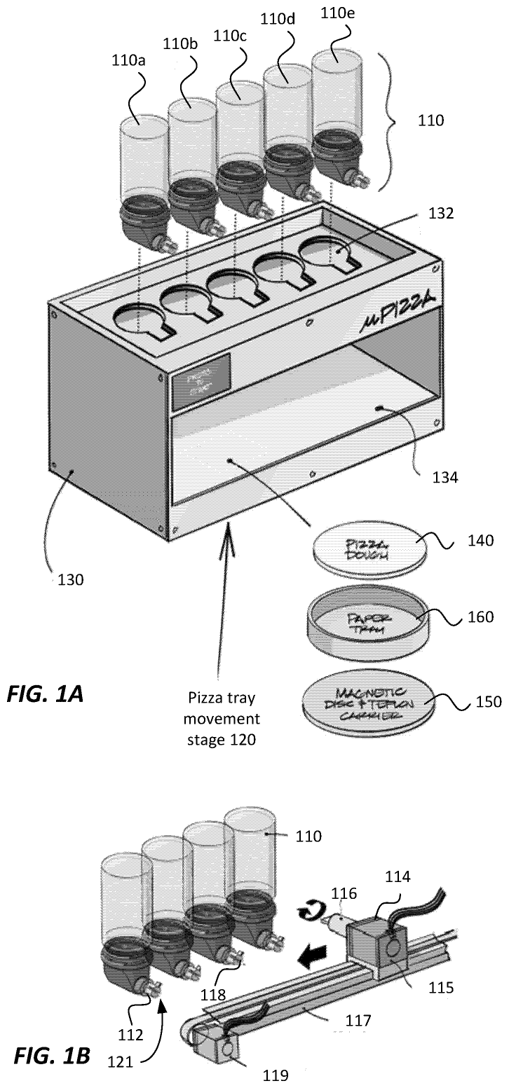

FIGS. 1A-1C show exploded views of a pizza ingredient dispensing device for dispensing sauces and toppings on a pizza dough according to some embodiments. The pizza ingredient dispensing device includes a plurality of containers 110 (e.g., 110a-110e as illustrated in FIG. 1A) for storing various ingredients, a pizza tray movement stage 120 (as illustrated in FIG. 1C) for holding and moving a pizza tray 150, and a housing 130 (as illustrated in FIG. 1A). The pizza tray 150 is configured to hold a pizza dough 140. The plurality of containers 110 are installed at the upper portion of the pizza ingredient dispensing device. Each container 110 can store a respective ingredient, such as a sauce, a cheese, and other toppings. The pizza tray movement stage 120 can be inserted into the lower portion of the housing 130 under the containers 110. In some embodiments, the bottom of the housing 130 can have a sealed high density polyethylen (HDPE) surface 134 for easy cleaning.

A pizza order can specify the requested ingredients (e.g., according to either a recipe or customized requests). For example, the requested ingredients can include a sauce (e.g., tomato sauce, marinara, spicy red, barbecue (BBQ) sauce, pesto, and the like, or a combination thereof), a cheese (e.g., mozzarella, provolone, feta, ricotta, cheddar, parmesan, goat, and the like, or a combination thereof), and other toppings (e.g., bacon, Canadian bacon, pepperoni, ham, sausage, salami, linguica, anchovies, chicken, meatballs, ground beef, clams, mushroom, basil, pineapple, olives, bell peppers, jalapenos, onion, garlic, artichoke hearts, sun dried tomatoes, spinach, and the like).

When a pizza order is received, the requested ingredients can be transmitted to a processor (e.g., a computing device). The processor can control the pizza ingredient dispensing device to place the requested ingredients on the pizza dough 140 before baking the pizza. The pizza tray movement stage 120 can move the pizza dough 140 under the containers 110 while ingredients are being dispensed on the pizza dough 140, so that the ingredients are distributed evenly on the pizza dough 140 (or as specified by the pizza order).

As illustrated in FIG. 1A, in some embodiments, a tram 160 can be used to hold the pizza dough 140. In one example, he tram 160 can have a planar lower surface and a raised circular rim. In operation, a selected pizza dough can be placed in the tram 160 and flattened so that the pizza dough 140 can extend to the raised rim. In another example, the dough is not flattened, and comes par baked and is placed into the tram 160. The raised rim can keep the dispensed ingredients on the pizza dough 140. In various embodiments, the tram 160 may be made of metal, paper, or other materials.

As illustrated in FIG. 1A, each container 110 can be inserted into a respective pass-through receptacle 132 at the top of the housing 130. The containers 110 are positioned next to each other in a row. Each container 110 can have a narrow and vertically elongated structure. In some embodiments, each container 110 can have a circular or a rectangular cross section so that many containers 110 can be placed next to each other across the width of the housing 130, as illustrated in FIG. 1A. In this way, the pizza ingredient dispensing device can have a relatively small horizontal footprint. In some embodiments, each container 110 can be removed from the receptacle 132 for refilling, cleaning, and/or being stored in a refrigerator. In some embodiments, as illustrated in FIGS. 1A and 1B, the containers 110 can have clear or translucent walls. An operator or a camera coupled to the processor can see or optically detect the fill level of the containers 110, and replenish the containers 110 with ingredients when the fill level is below a predetermined threshold level.

In some embodiments, the pass-through receptacles 132 can be positioned on a sub-mount (not shown) that can be removed from the housing 130. In this way, all of the containers 110 can be removed together from the housing 130 along with the sub-mount, and be stored in a refrigerator when the pizza ingredient dispensing device is not operating. When the pizza ingredient dispensing device is back in operation, the contains 110 with the sub-mount can be placed back on the housing 130. In some embodiments, the plurality of containers 110 can be surrounded by a cooling system to help keep the ingredients fresh. The pizza ingredient dispensing device can be compact and self-contained.

As illustrated in FIG. 1B, each container 110 can have an outlet 112 that allows the ingredient to be dispensed from the container 110 and be placed on the pizza dough 140. According to some embodiments, the ingredients can flow or drop out of the containers 110 by gravity. Each container 110 can have an output mechanism 118 at the outlet 112. For example, the output mechanism 118 can include an auger or a valve (the output mechanism 118 is referred herein generally as a “valve”). The type of the container 110 and the type of the valve 118 can depend on the type of ingredient the individual container 110 stores. For example, tomato sauce can be stored in a liquid container or a bag, and the valve 118 can be a liquid valve or a liquid volume control mechanism such as a control volume pump. For a solid topping such as cheese, meat, and vegetables, a solid material auger or feed mechanism can be used. For some toppings, such as pepperoni slices, other three-dimensional shapes and other types of dispending mechanisms can be used.

According to some embodiments, the valve 118 can include a rotational member that can be rotated to control the output of the ingredient onto the pizza dough 140. For example, the rotational member can include a rod having a blade slot 121, or other suitable rotational drive connection feature. The blade slot 121 can extend outwardly. As illustrated in FIG. 1B, a rotational motor 114 can be coupled to an actuator such as a blade shaft 116. The blade shaft 116 can engage with the blade slot 121 of a given valve 118. The rotational motor 114 can be attached to a carriage 115, which can be moved along a horizontal x-axis track 117 that is positioned adjacent to the plurality of containers 110. The carriage 115 can have linear bearings to provide a low friction and smooth movement of the carriage 115 on the track 117. A linear motor 119 (e.g., a multiplex stepper motor) can be used for moving the carriage 115 to appropriate positions along the track 117.

For example, the linear motor 119 can be controlled by the processor to position the blade shaft 116 in alignment with the blade slot 121 of a respective valve 118 for dispensing the ingredient stored in a respective container 110. For example, when a specific ingredient is required for a pizza order, the linear motor 119 can move the blade shaft 116 in alignment with the blade slot 121 of the valve 118 of the container 110 that stores the specific ingredient. In some embodiments, the blade slots 121 of all the containers 110 can be normally aligned horizontally. This would allow the blade shaft 116 to move horizontally into alignment with any desired blade slot 121. When the blade shaft 116 is engaged with a desired blade slot 121, the rotational motor 114 can actuate the blade shaft 116 to rotate that blade slot 121, so as to output a desired quantity of the specific ingredient onto the pizza dough 140. The pizza tray 150 with the pizza dough 140 held thereon is positioned and moved by the pizza tray movement stage 120 accordingly while the specific ingredient is being dispensed so that the specific ingredient is evenly distributed on the pizza dough 140 (or as specified by the pizza order).

In some embodiments, the required quantity or volume of the ingredient can be approximated by rotating the blade slot 121 a corresponding number of turns for the required volume. To maintain the horizontal orientation of the blade slots 121, the rotations of the blade slots 121 can be in 180-degree increments so that the blade slots 121 will remain in the horizontal orientation after the ingredients have been placed on the pizza dough 140. For example, if each 180-degree rotation of the blade slot 121 emits 1 ounce of tomato sauce and the pizza requires 4 ounces of tomato sauce, the rotational motor 114 can cause the blade slot 121 to be rotated by 4×180 degrees=720 degrees or 2 full rotations. In some embodiments, the system can back off the rotations to prevent ingredients from dispensing. For example, if a personalized slice needs more or less ingredients, the system can adjust for that.

Referring to FIG. 1B, if any of the blade slots 121 are not left in a horizontal orientation, the blade shaft 116 may not be able to move horizontally past the misaligned blade slot 121. In some embodiments, various systems can be used to prevent misalignment of the blade shaft 116 with respect to the blade slots 121. For example, a magnet can be mounted on the input coupling on the housing 130 to register the orientation relative to the rotational motor 114 to ensure that the system will not accidentally break and/or the metal tray may be attached to tray moving mechanism with a magnet so that it does not move around. In some embodiments, the blade slot 121 can have a tapered groove, so that the blade slot 121 can be rotated by the blade shaft 116 into proper alignment as the blade shaft 116 is moved horizontally into alignment with the blade slot 121. The tapered groove can force the blade shaft 116 coupling into a horizontal orientation as the housing is placed in its locked position in alignment with the blade slot 121 before rotation. In one implementation, when the hopper is put into place there is a feature that guides the drive shaft to a specific orientation (e.g., similar to a funnel), such that it will facilitate the drive motor slot to slide into the groove on the hopper shaft so that it can be driven by the hopper motor.

In other embodiments, the blade shaft 116 can be retracted when the rotational motor 114 is moved along the track 117 and be extended when the blade shaft 116 is moved into alignment with one of the blade slots 121. Then the rotational motor 114 can rotate the blade shaft 116 so as to rotate the corresponding blade slot 121 to deposit the ingredient on the pizza dough 140. The extension/retraction mechanism can allow the system to operate even when the blade slots 121 are not in perfect horizontal alignment.

In some embodiments, the pizza ingredient dispensing device can have an integrated measurement system to control the amount of pizza sauce applied to the pizza dough and also control the quantity of toppings placed on the pizza dough. The integrated measurement system can allow a large degree of variability for customized pizzas based on the customer's preferences. The integrated measurement system can also provide a high degree of consistency.

In some embodiments, a weight sensor or a scale can be integrated into the pizza ingredient dispensing device, so that the weight of the pizza dough 140 with dispensed ingredients can be detected during the ingredient dispensing process. As the ingredients are placed on the pizza dough 140, the weight sensor can detect the increased weight. The detected weight can be transmitted to the processor, and the processor can control the rotational motor 114 accordingly. When the specified weight or quantity of the ingredient has been placed on the pizza dough 140, the processor can control the rotational motor 114 to stop the flow of the ingredient. The linear motor 119 can then move the blade shaft 116 to the container 110 of a next desired ingredient. This process can be repeated until all requested ingredients for the pizza order have been placed on the pizza dough 140.

The number of containers 110 in a pizza ingredient dispensing device can be, for example, four, six, eight, and the like, depending on the number of ingredients that are available or offered. In some embodiments, multiple pizza ingredient dispensing devices can be used to process a pizza dough sequentially to create a single pizza with many different toppings. The size, shape, design, and operation of the containers 110 can change depending on the physical characteristics of the ingredients. For example, a pepperoni container can include a slicing assembly, so that an elongated uncut piece of pepperoni can be cut into thin slices and be deposited onto the pizza dough by a special container.

The plurality of containers 110 for various ingredients can be arranged on the pizza ingredient dispensing device in an order according to the normal sequence of topping placement. For example, a pizza can normally be constructed by placing sauce on the pizza dough first, followed by cheese and then other toppings. The containers 110 for sauces, such as tomato sauce, marinara, spicy red, BBQ sauce, pesto, alfredo, and the like, can be grouped together on a first portion of the pizza ingredient dispensing device. The containers 110 for cheeses, such as mozzarella, provolone, feta, ricotta, cheddar, parmesan, goat, and the like, can be positioned on a second portion of the pizza ingredient dispensing device adjacent to the containers 110 for sauces. The containers 110 for toppings, such as bacon, Canadian bacon, sausage, salami, linguica, anchovies, chicken, meatballs, ground beef, clams, mushrooms, basil, pineapple, olives, bell peppers, jalapenos, onion, garlic, artichoke hearts, sun dried tomatoes, spinach, and the like, can be positioned on a third portion of the pizza ingredient dispensing device adjacent to the containers 110 for cheeses. By arranging the sauces, chesses, and the toppings, the rotational motor 114 can be moved quickly and efficiently through the first portion, the second portion, and the third portion of the pizza ingredient dispensing device sequentially to place the requested ingredients on the pizza dough without backtracking.

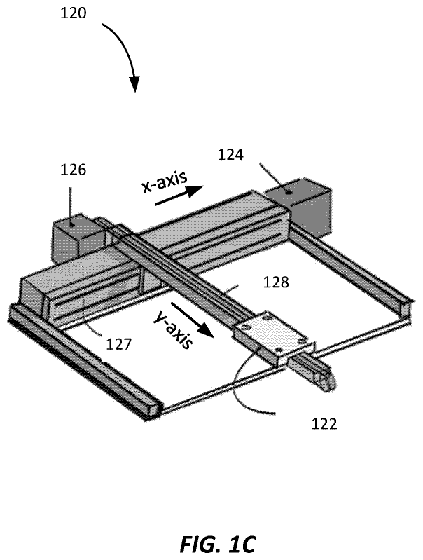

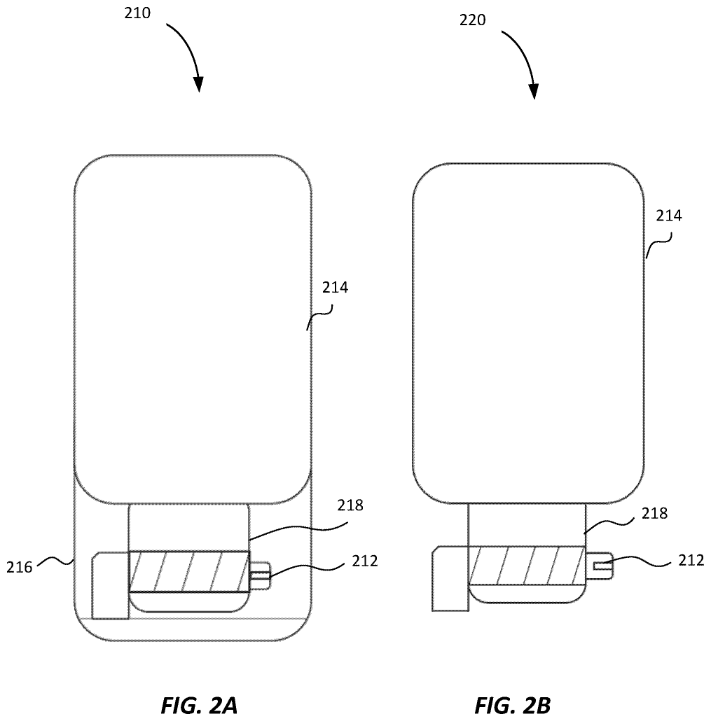

FIG. 2A illustrates a side view of a sealed container 210 according to some embodiments. The sealed container 210 can include a base 218 with an integrated valve or auger 212, and a storage compartment 214. The base 218 can be a rigid structure that can be placed in a receptacle 132 of the pizza ingredient dispensing device with the integrated valve/auger 212 being rigidly held, so that a blade shaft 116 can be used to engage and turn the valve/auger 212. The storage compartment 214 can be transparent so that a user can see the amount of ingredient remaining therein, and can replenish it when the amount of ingredient is running low or depleted. For example, the storage compartment 214 can be made of plastic or glass. According to some embodiments, to refill the storage compartment 214, the storage compartment 214 can be separated from the base 218. Ingredient can be placed into the storage compartment 214 through an opening (not shown). Once filled, the sealed container 210 can be placed back in the receptacle 132 of the housing 130. The sealed container 210 also includes an enclosure 216 that encloses the storage compartment 214 and the base with the integrated valve/auger 212. The enclosure 216 can be sealed.

FIG. 2B illustrates a side view of an unsealed container 220 according to some embodiments. The unsealed container 220 is similar to the sealed container 210 shown in FIG. 2A, except that it does not include the enclosure 216.

According to various embodiments, the containers 210 or 220 can have other structures and configurations. For example, the storage compartment 214 can be a clear plastic bag with a zip lock resealable top or can be a more rigid structure with a removable and sealable lid. When the ingredients need to be refilled, the resealable top or the lid can be opened and the ingredients can be placed into the storage compartment 214.

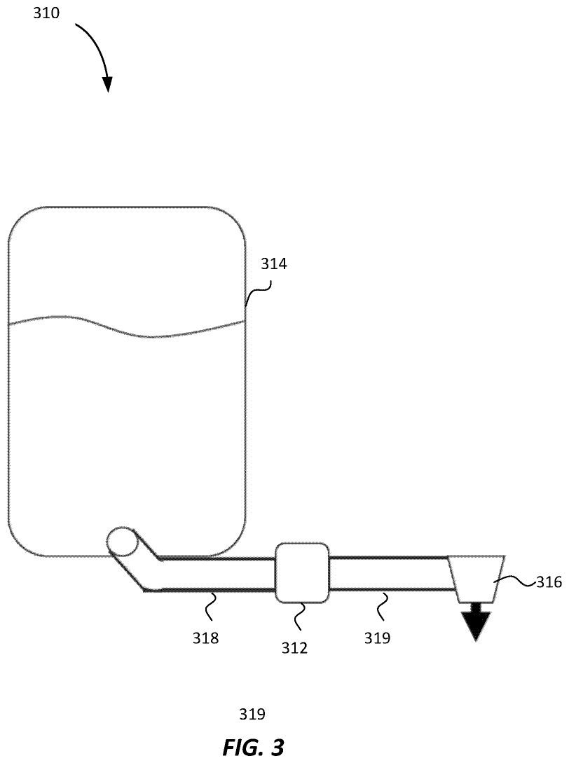

FIG. 3 illustrates a side view of a container 310 according to some embodiments. The container 310 can be used to store liquid ingredients, such as sauces. The container 310 can include a liquid storage compartment 314. The liquid storage compartment 314 can be a plastic bag, a rigid plastic container, a glass container, or the like. One end of a tube 318 can be coupled to a lower portion of the liquid storage compartment 314. A valve 312 can be coupled to the other end of the tube 318. The valve 312 can be coupled to an output tube 319 with an outlet 316. The valve 312 can be opened to allow the sauce to flow by gravity onto a pizza dough. Alternatively or additionally, a pump (not shown) can be used to pump the sauce onto the pizza dough. In some embodiments, the pump can be a fluid volume control pump, or a controlled volume pump that can deliver a specific quantity of sauce that is proportional to the number of rotations of the pump. The system can control the amount of sauce that is placed on the pizza dough depending on the pizza recipe or a personalized pizza order. Once the required amount of sauce has been placed on the pizza dough, the valve 312 can be closed to prevent the sauce from leaking from the liquid container 310.

When the ingredient has been depleted, a container 110, 210, 220, or 310 can be refilled or replaced. In some embodiments, a container 110, 210, 220, or 310 can remain in the pizza ingredient dispensing device, and the pizza ingredient dispensing device can continue to operate during the refilling process. Alternatively, the operation of the pizza ingredient dispensing device can be stopped (e.g., by an operator or by the processor) while the container 110, 210, 220, or 310 is being refilled. For example, an empty container 110, 210, 220, or 310 can be refilled or be replaced by another container 110, 210, 220, or 310 fully filled with the same ingredient. Once the containers 110, 210, 220, or 310 are replenished, the operation of the pizza ingredient dispensing device can be resumed by the operator or by the processor.

The containers 110, 210, 220, or 310 may need to be cleaned, sterilized or replaced from time to time. In some embodiments, the base 218 and the integrated valve/auger 212 can be separated from the storage compartment 214 before cleaning. Cleaning can be performed manually with detergent and water or in a disk washing machine. After cleaning, the containers 110, 210, 220, or 310 can be refilled with ingredients and be put back in the pizza ingredient dispensing device.

In other embodiments, an entire container 110, 210, 220, or 310 can be placed in a sealable plastic bag or a sealable rigid enclosure 216, as illustrated in FIG. 2A. The sealed containers 210 filled with ingredients can be provided through a franchiser ingredient distribution service. For example, the sealed containers 210 filled with ingredients can be delivered from a central distribution center and stored in a refrigerator at a pizza franchise. When a container 210 is depleted and needs to be replaced, the empty container 210 can be removed and replaced by another container 210 from the refrigerator. In some embodiments, the lower part of the enclosure 216 can be sealed by a removable cover. The cover can be removed to expose the lower portion of the container 210 before the base 218 is being inserted into the receptacle 132 of the pizza ingredient dispensing device. For example, a user can remove two pull tabs at the base 218 prior to loading the container 210 into the pizza ingredient dispensing device.

In some embodiments, the pizza ingredient dispensing device can include sensors that can detect when a container 110, 210, 220, or 310 needs to be refilled. For example, a weight sensor can detect the weight of each container 110, 210, 220, or 310. An optical sensor, such as a camera, can identify the fill level of each container 110, 210, 220, or 310. When a sensor determines that the fill level of a container 110, 210, 220, or 310 is low, the pizza ingredient dispensing device can inform an operator, who can stop the pizza ingredient dispensing device and refill or replace the container 110, 210, 220, or 310. In some embodiments, the containers 110, 210, 220, or 310 can be designed so that they can be easily removed from the pizza ingredient dispensing device by simply lifting the containers 110, 210, 220, or 310 from the upper portion of the pizza ingredient dispensing device. The containers 110, 210, 220, or 310 can be stored in a refrigerator or freezer when the pizza ingredient dispensing device is not operating.

According to some embodiments, as illustrated in FIG. 1C, the pizza tray movement stage 120 can include a magnetic coupling conveyer 122. The pizza tray 150 can include a magnetic disc, so that the pizza tray 150 can be held against the magnetic coupling conveyer 122 via a magnetic force. The magnetic coupling conveyer 122 can include a magnet, such as a high-strength permanent magnet or an electromagnet. The pizza tray movement stage 120 can include a first linear guide 127 and a second linear guide 128. The second linear guide 128 can move along the first linear guide 127 in the x-axis direction via a first motor 124. The magnetic coupling conveyer 122 can move along the second linear guide 128 in the y-axis direction via a second motor 126. The x-axis and the y-axis define the plane of the pizza dough 140.

In some embodiments, the pizza tray 150 can have a non-sticking coating (e.g., a Teflon coating) on its top surface. A magnet or a ferromagnetic material can be attached to a lower surface of the pizza tray 150. In some embodiments, a low friction sliding surface can be created at the bottom side of the pizza tray 150 by applying a Teflon coating to allow the pizza tray 150 to slide easily over the magnetic coupling conveyer 122. This arrangement allows the pizza tray 150 to slide on the smooth, low friction surfaces. As such, the separation of the mechanical movement assemblies can separate the loose ingredients from the machinery that can allow the areas of the machine that can come into contact with food to be easily cleaned.

In some embodiments, in addition to translational movements along the x-axis and y-axis, the pizza dough movement stage 120 can also rotate the pizza tray 140. For example, the pizza dough movement stage 120 can include a rotational motor (not shown in FIG. 1C) configured to rotate the pizza tray 150. The rotational motor can cause a rotation about the z-axis that is perpendicular to the plane of the pizza dough 140 defined by the x-axis and y-axis.

With reference to FIG. 1A, when assembled, the pizza tray movement stage 120 can be positioned at the bottom of the housing 130. A middle portion of the housing 130 can be an open space that allows the pizza tray 150 to be inserted or removed from the pizza ingredient dispensing device. The placement of the pizza tray 150 onto the magnetic coupling conveyer 122 can be performed manually or with a robotic arm.

Once the pizza tray 150 with a pizza dough 140 has been placed onto the magnetic coupling conveyer 122, an operator can press a start button to start adding ingredients to the pizza dough 140. The processor can control the movement of the magnetic coupling conveyer 122 to move the pizza dough 140 under the containers 110 according to the requested ingredients of a pizza order. The processor can also coordinate the emission of the ingredients from the containers 110 with the movement of the pizza dough 140 under the containers 110 so that the ingredients are distributed evenly on the pizza dough 140.

In some embodiments, in order to distribute an ingredient evenly over the entire pizza dough 140, the pizza tray movement stage 120 can move the pizza dough 140 in a spiral or a serpentine path based on the ingredient output rate (volume per minute or weigh per minute) so that the entire area of the pizza dough 140 except the outer perimeter is covered with the ingredient. The pizza ingredient dispensing device can also be controlled to adjust the output rate based on a custom order. For example, a special order may require extra sauce, and the processor can increase the sauce output rate so that the pizza has extra sauce.

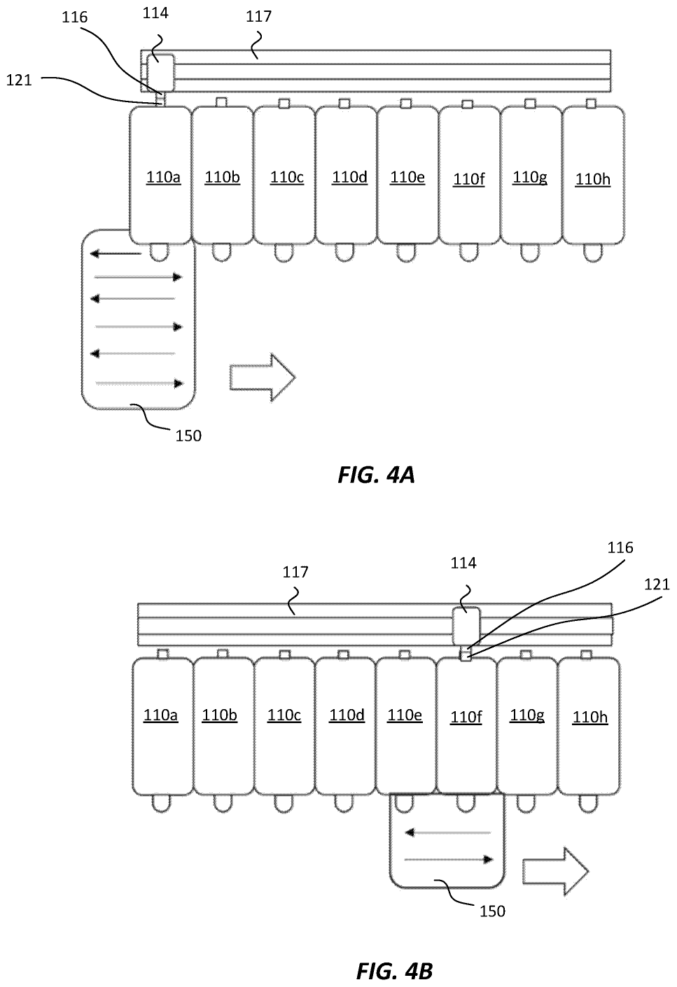

FIGS. 4A and 4B illustrate an ingredient dispensing process using the pizza ingredient dispensing device according to some embodiments. A plurality of containers 110a-110h are arranged next to each other in a row. Each container 110 has a valve, which can include a blade slot 121, as described above with respect to FIG. 1B. A rotational motor 114 is coupled to a blade shaft 116. The rotational motor 114 can be moved along a track 117 (e.g., along the x-axis), so that the blade shaft 116 can selectively engage the blade slot 121 of a respective blade shaft 116 of a container 110.

For example, as illustrated in FIG. 4A, the first container 110a on the left can store a sauce. The processor can place the pizza tray 150, with a pizza dough placed thereon, directly under the outlet of the first container 110a. The processor can move the pizza tray 150 in a serpentine pattern while the sauce is being dispensed onto the pizza dough. For example, the pizza tray 150 can initially be position so that a corner of the pizza dough is under the outlet. The pizza tray 150 can be moved in the x-axis direction while the sauce is flowing from the first container 110a onto the pizza dough. When the edge of the pizza dough has been reached, the pizza tray 150 can be moved in the y-axis direction and then be moved in the reverse x-axis direction while the sauce is flowing from the first container 110a. This process can continue until the entire upper surface of the pizza dough is covered with the sauce. In the example illustrated in FIG. 4A, the pizza tray 150 has a rectangular shape, which can be more suitable for a pizza dough with a rectangular shape. According to various embodiments, the pizza tray 150 may come in a variety of different shapes, sizes, and/or materials.

Afterward, the rotational motor 114 can be moved along the track 117 so that the blade shaft 116 engages with the blade slot 121 of another container with a desired topping (e.g., the container 110f as illustrated in FIG. 4B). The processor can control the movement of the pizza tray 150 in a serpentine pattern under the outlet of that container 110f. This process can be repeated until all desired toppings have been placed on the pizza dough. An operator can then remove the pizza tray 150 with the pizza dough from the pizza ingredient dispensing device, or the processor can control a robotic arm to remove the pizza tray 150 from the pizza ingredient dispensing device.

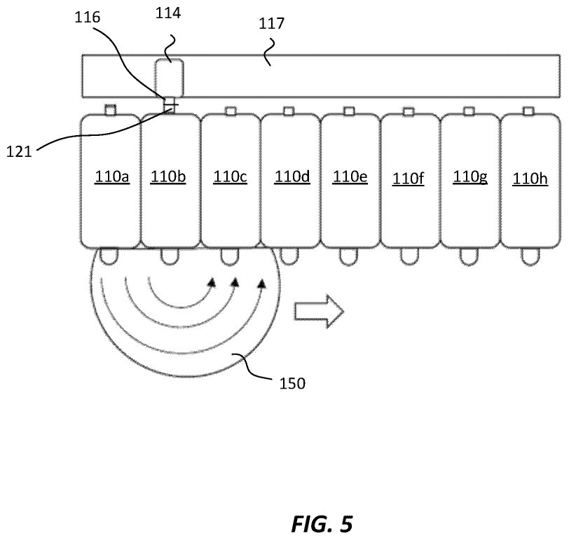

FIG. 5 illustrates an ingredient dispensing process using the pizza ingredient dispensing device according to some embodiments. In this example, the pizza tray 150 has a circular shape, which can be more suitable for a pizza dough with a circular shape. In addition to linear movements along the x-axis and y-axis, the pizza tray 150 can be moved in a rotational motion. In some embodiments, the rotational motion and linear motion of the pizza tray 150 can be controlled so that the ingredient is placed on the pizza dough in a spiral pattern or other suitable patterns, for even distribution of the ingredient over the pizza dough.

In some embodiments, the pizza ingredient dispensing device can make pizzas with half or quarter pizza variations. For example, if a pizza is ordered with one half mozzarella and the other half feta, the processor can control the movement of the pizza dough with respect to the appropriate cheese containers so that one half of the pizza dough is covered with mozzarella and the other half is covered with feta. The system can process custom cheese orders in fractions such as ½, ⅓, ¼, and the like. Similarly, the system can process custom topping orders in fractions such as ½, ⅓, ¼, and the like.

While the pizza ingredient dispensing device has been illustrated as a single unit for placing sauce(s), cheese(s), and toppings on the pizza dough, in other embodiments, it is possible to have multiple pizza ingredient dispensing devices that can dispense ingredients in sequence or in parallel. In a sequential configuration, a first pizza ingredient dispensing device can apply a first group of ingredients to the pizza dough such as sauces and cheeses. The pizza tray 150 with the pizza dough can then be transferred to a second pizza ingredient dispensing device that can put toppings onto the pizza dough. The multi-module configuration may be necessary if many possible sauces, cheeses, and toppings are available on the menu for custom orders. The multiple pizza ingredient dispensing devices can be placed side by side so that the pizza tray 150 with the pizza dough can be quickly and easily moved from module to module by hand or by a robotic transfer mechanism. In parallel configurations, multiple pizza ingredient dispensing devices can each prepare their own pizzas independently so that cumulative maximum pizza output can be directly proportional to the number of pizza ingredient dispensing devices.

When all requested ingredients have been placed on the pizza dough, the system can issue a completed signal and the operator can then move the pizza to an oven. In some embodiments, the processor can move the magnet downward away from the smooth surface of the magnetic coupling conveyer 122 so that the magnetic attraction force to the pizza tray 150 is decreased. The pizza tray 150 can then be more easily removed from the pizza ingredient dispensing device. Alternatively, if an electromagnet is used, power to the electromagnet can be turned off to allow the pizza tray 150 to be easily removed from the pizza ingredient dispensing device. In some embodiments, a robotic arm can be used to transfer the pizza from the pizza ingredient dispensing device to an oven.

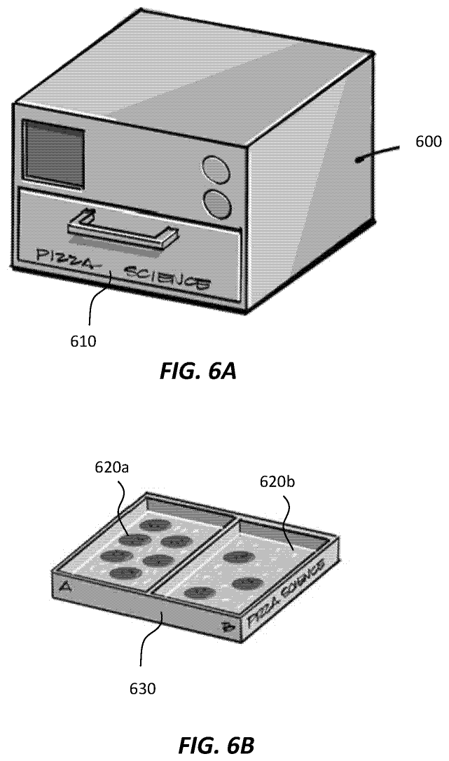

FIGS. 6A and 6B illustrate a relatively small pizza oven 600 that can be quickly and efficiently heated according to some embodiments. As illustrated in FIG. 6A, the pizza oven 600 has a door 610 that can normally be closed. When a pizza or pizzas 620a and 620b have been assembled in the pizza ingredient dispensing device and are ready to be cooked, the door 610 can be opened so that the pizza(s) can be inserted in the pizza oven 600. The door 610 can then be closed and the pizzas 620a and 620b can be cooked. Once the pizzas 620a and 620b are fully cooked, the door 610 can be opened and the pizzas 620a and 620b can be removed from the pizza oven 600. The pizzas 620a and 620b can be placed in a pizza box 630, as illustrated in FIG. 6B. Another pizza (or pizzas) can then be inserted into the pizza oven 600. If there are no more immediate orders, power to the pizza oven 600 can be turned off to conserve electrical power. In some embodiments, the system can track or be informed that the customer's arrival is delayed and then delay the baking of the pizza so that the pizza is freshly cooked when the customer arrives.

In some embodiments, the pizza oven 600 can be a small microwave oven that is just large enough to cook a single pizza or even just a single slice of pizza. Small pizzas or pizza slices are popular lunch options because an individual person would just need enough food for lunch. A customer can order a pizza with desired ingredients and in the desired size, instead of ordering a large pizza and bringing home the leftover. The small microwave oven can be heated to the required temperature quickly and efficiently with much less power required compared to a large pizza oven.

A pizza can be cooked at a predetermined temperature for a predetermined period of time. In some embodiments, the predetermined temperature and cooking time can be based on the pizza dough (e.g., thin crust or thick crust, or type of dough), the type and amount of cheese, and the toppings selected for the pizza. In some embodiments, the predetermined temperature and cooking time can be adjusted based on customer preferences. For example, customers can select from soft crust, charred crust, or crispy crust options when placing pizza orders through an app or a website. For instance, in order to create the charring, the pizza oven 600 can be set to a higher-than-normal temperature. When cooked at a higher temperature, sugars in the pizza dough can be released and can be caramelized. The crust can also darken and become bitter. The combination of flavors can create a balanced flavorful pizza. A charred Neapolitan pizza crust can complement a tomato sauce to improve the flavors.

In some embodiments, alternatively or additionally, the pizza oven 600 can include heating mechanisms such as convection heating elements, electrical heating elements, gas fire, wood fire, and the like. The pizza oven 600 can include a high temperature cooking surface such as a pizza stone that can require a preheating period before a pizza is inserted. Once the cooking surface is heated, the pizza can be placed in the pizza oven 600 and be cooked for a predetermined cooking time based on the quantity and types of ingredients placed on the pizza. The processor may have an algorithm that can adjust the cooking time and cooking temperature based on the pizza ingredients. For example, a pizza that have more ingredients such as extra sauce, extra cheese, and dense toppings can require longer cooking time or a higher cooking temperature than a no cheese pizza and/or with few toppings.

In some embodiments, a pizza that is being cooked in the pizza oven 600 can be monitored with sensors and/or cameras. For example, a temperature sensor can detect the temperature of the pizza. A pizza may be properly cooked with the upper and/or lower surface of the pizza reaches a predetermined temperature. A camera can detect the color of the cheese after it has melted, or detect a char level or a blister level of the crust. A weight or force sensor can detect a weight loss of the pizza from water evaporating from the pizza dough. The sensors can communicate with the processor and the processor can analyze the sensor data. When the sensor data indicates that the pizza is fully cooked, the processor can turn off the pizza oven 600 and inform the operator that the pizza is fully cooked and is ready. The cooked pizza can be placed in a box 630 or other delivery container for delivery to or pickup by the customer.

In some embodiments, the pizza ingredient dispensing device and the pizza oven 600 can be modular, easily moveable, and/or stackable. The modular configuration can allow a pizza business to scale incrementally as business increases over time. A business owner can start with one pizza ingredient dispensing device and one pizza oven at a retail location. As business improves, the output can be increased by installing additional pizza ingredient dispensing devices and pizza ovens. The capacity can be increased while not increasing the required kitchen space by stacking the modules. For example, multiple pizza ingredient dispensing devices can be stacked on top of each other and multiple pizza ovens can also be stacked on top of each other. It may also be possible to stack a pizza ingredient dispensing device on a pizza oven. By stacking the modules, the horizontal footprint of the pizza making apparatus can be minimized.

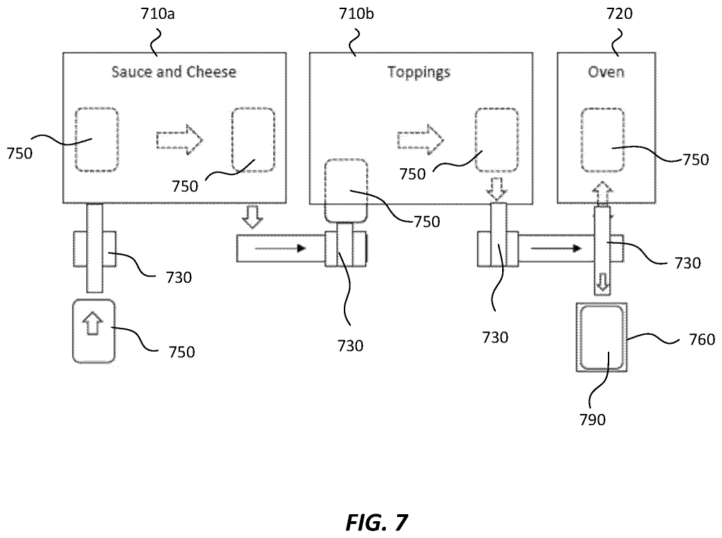

FIG. 7 illustrates a robotic system for a pizza making apparatus according to some embodiments. As illustrated, the pizza making apparatus includes a sauce and cheese module or device 710a and a topping module or device 720. The number of sauce and topping modules can be less than or more than two. The pizza making apparatus also includes an oven 720, and at least one robotic arm 730. When a pizza order is received, a processor can cause the robotic arm 730 to move a pizza tray 750 filled with a selected pizza dough from a storage area to the sauce and cheese module or device 710a. The processor then coordinates the movement of the pizza tray 750 with the dispensing of the selected sauce and cheese onto the pizza dough as described above. Once the sauce and cheese have been placed on the pizza dough, another or the same robotic arm 730 can move the pizza tray 750 to the topping module or device 710b. The processor then coordinates the movement of the pizza tray 750 with the dispensing of the selected toppings onto the pizza dough as described above. Once the toppings are placed on the pizza dough, another or the same robotic arm 730 can move the pizza tray 750 to the oven 720. The processor can control the oven 720 to cook the pizza. When the cooking is complete, another or the same robotic arm 730 can remove the pizza from the oven 720. The pizza 790 can be removed from the pizza tray 750 and placed in a delivery box 760 for the customer.

According to some embodiments, a pizza franchise system can include a computer server that is in communication with a plurality of pizza making apparatuses and with customer computing devices (e.g., mobile computing devices and desktop computing devices). A customer can order personalized pizzas through a software (e.g., an app) downloaded on a customer computing device (e.g., a mobile phone or a desktop computer). The software can display a user interface for personalized pizza ordering. A customer can also order personalized pizzas through a web browser running a customer computing device.

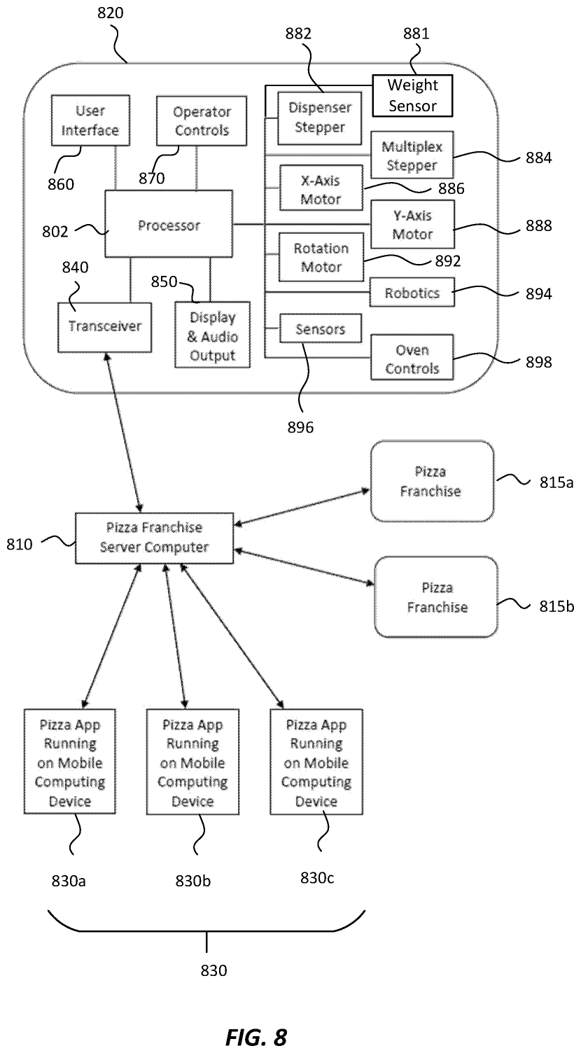

FIG. 8 illustrates a block diagram of a pizza franchise system according to some embodiments. The pizza franchise system includes a computer server 810. The computer server 810 can communicate with one or more pizza making apparatuses 820 (e.g., 820a and 820b) through a communication network (e.g., the Internet). Each pizza making apparatus 820 may be operated by a pizza franchise 815a-815b. The computer server 810 can also communicate with one or more customer computing devices 830 (e.g., 830a, 830b, and 830c) through the communication network. Each customer computing device 830 can run a pizza ordering program (e.g., a webpage or an app). Customers can use the pizza ordering program to order personalized pizzas, for example, by selecting pizza doughs, sauces, cheeses, and other toppings, crust preferences, and other options. A pizza order can be transmitted to a selected pizza franchise 815a-815b (e.g., based on location or the customer's choice). Customers can also make payments through the pizza ordering program, and funds can be transferred to the financial account of the pizza franchise 815a-815b. The pizza franchise 815a-815b can make the pizza according to the specifications of the pizza order.

As illustrated in FIG. 8, each pizza making apparatus 820 (operated by a respective pizza franchise) can include a processor 830, and a transceiver 840 for communicating with the computer server 810. Each pizza making apparatus 820 can also include a user interface 860, operator controls 870, and/or visual and audio output devices 850. The processor 830 can be communicatively coupled to a pizza ingredient dispensing device and a pizza oven. Once a pizza order is transmitted to the pizza making apparatus 820, the processor 830 can control the operation of the pizza ingredient dispensing device and the pizza oven to make a pizza according to the pizza order.

For example, the processor 830 can control the ingredient dispensing motors 882 (e.g., the rotational motor 114 as illustrated in FIG. 1B), the multiplex motor 884 (e.g., the linear motor 119 as illustrated in FIG. 1B), the x-axis motor 886 and the y-axis motor 888 for moving the pizza dough (e.g., the x-axis motor 124 and the y-axis motor 126 as illustrated in FIG. 1C), and the rotation motor 892 for rotating the pizza tray. The processor 830 can also control robotics 894 for inserting and removing the pizza dough into or out of the pizza ingredient dispensing device, or for inserting and removing the pizza into or out of the pizza oven.

In some embodiments, the pizza ingredient dispensing device can include a weight sensor 890. While ingredients are being placed on the pizza dough, the weight sensor 890 can detect the increase in the weight of the pizza. The processor 830 can receive weight signals from the weight sensor 890, and can determine and control the quantities of ingredients placed on the pizza dough precisely based on the weight signal.

The processor 830 can control the oven controls 898 of the pizza oven to bake the pizza according to the pizza order. The processor 830 can communicate with the sensors 896 positioned in the pizza oven 898, and control the oven controls 898 based on sensor data received from the sensors 896. Once the pizza has been fully cooked, the finished pizza can then be placed in a box and given to the customer. The sensors 896 can include temperature sensors, cameras, and weight sensors. For example, the temperatures sensors can detect the temperature of the pizza, and the processor 830 can stop the cooking when the pizza has reached the desired temperature.

In some embodiments, cameras can be positioned inside the pizza ingredient dispensing device. The pizza making apparatus 820 can store images of pizzas with the proper quantity of ingredients. The cameras can monitor the pizza during the placement of ingredients on the pizza and the processor 830 can stop the dispensing of ingredients onto the pizza when the camera image substantially matches the stored pizza image with the proper amounts of ingredients. In some embodiments, the pizza making apparatus 820 can also store images of pizzas with the proper cooked crust. Cameras positioned in the pizza oven can monitor the pizza being cooked, and the processor 830 can stop the cooking when the camera image substantially matches the stored pizza image with the proper cooked crust.

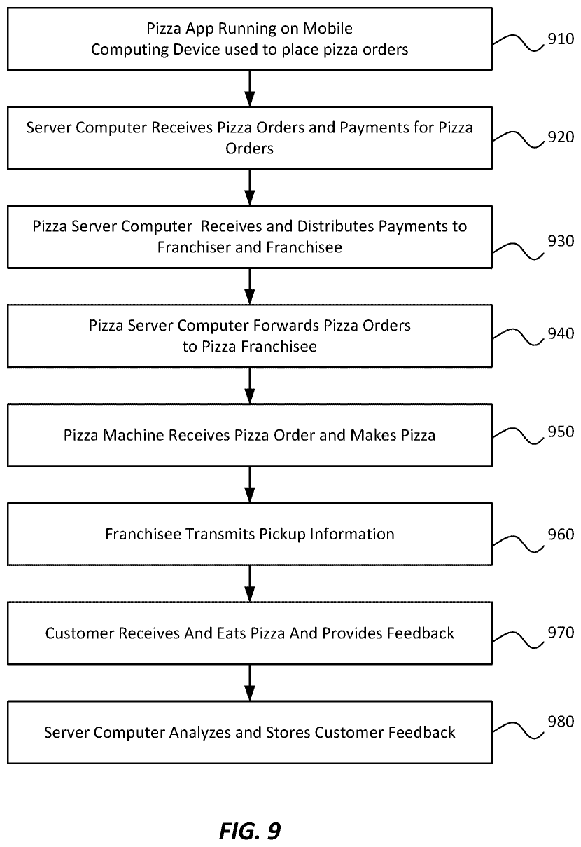

FIG. 9 is a flow diagram of method steps for processing pizza orders via a computing server according to some embodiments.

At 910, a pizza app can be running on a mobile computing device and orders can be input through the user interface. Alternatively, the customer can use a browser to log into a pizza ordering website. The user interface can have an interactive menu that can allow customers to create completely personalized pizzas and/or order a predesigned pizza. For customer pizza orders, a user can specify the type of pizza dough, the type of pizza sauce, the type of cheese, the toppings, and other pizza instructions.

The pizza app can also have an electronic payment input for the ordered pizzas that can use credit cards, debit cards, and other electronic payment methods such as PayPal, Venmo, Apple Pay, etc. The server can automatically calculate and transmit the franchisee and franchiser payments to their respective financial accounts. Once payment has been confirmed, the order can be transmitted electronically to a pizza franchise server that can forward the order to a designated pizza franchise.

At 920, a server computer receive pizza orders and payments for pizza orders. At 930, the server computer receives and distributes payments to a franchiser and franchisee. At 940, the server computer forwards pizza orders to a pizza franchise. When an order is received from a pizza app, the processor of the server computer can provide information to the pizza preparation station operator including the type of crust and the ingredients on the pizza. At 950, a pizza machine receives the pizza order and makes the pizza. In one embodiment, the pizza machines operates automatically upon receive of an order. In other embodiments, the order is sent to a pizza machine operator that operates the pizza machine. The pizza operator can place the selected crust into the pizza dough holder and then place the pizza dough holder in the pizza preparation station over the magnetic coupling conveyor. The operator can then press the start button to start the automated pizza making process. In other embodiments, the dough holders may be stored and refrigerated with the pizza dough. A robotic arm can remove the dough holders and dough from a storage area and place the pizza dough holder in the pizza preparation station over the magnetic coupling conveyor.

With the dough in the pizza holder placed in the pizza preparation station, the processor of the pizza machine can actuate the multiplex stepper to move the dispenser stepper to the desired sauce container. The processor can also actuate the X-axis motor and the Y-axis motor to move the magnetic coupling conveyer so that a portion of the pizza dough holder is under the selected pizza sauce output. The processor can rotate the dispenser stepper to control the flow of the selected sauce onto the pizza dough while the X-axis and the Y-axis motors move the pizza dough under the sauce output. The movement pattern of the dough can be linear and/or spiral to cause the sauce to be evenly distributed over the entire pizza dough.

Once the pizza sauce has been evenly applied to the dough, the processor can actuate the X-axis and the Y-axis motors to move the dough to the selected cheese dispenser. The processor can also actuate the multiplex stepper to move the dispenser stepper to the desired cheese container. The processor can then rotate the dispenser stepper to control the flow of the selected cheese onto the pizza dough while the X-axis and the Y-axis motors move the pizza dough under the cheese output. The movement pattern of the dough can cause the cheese to be evenly distributed over the sauce and pizza dough.

Once the cheese has been evenly applied to the dough, the processor can actuate the X-axis and the Y-axis motors to move the dough to the selected topping dispenser. The processor can again actuate the multiplex stepper to move the dispenser stepper to a first desired topping container. The processor can then rotate the dispenser stepper to control the flow of the selected topping onto the pizza dough while the X-axis and the Y-axis motors move the pizza dough under the topping output. The movement pattern of the dough can cause the topping to be evenly distributed over the cheese, sauce, and pizza dough. This same process can be used for all selected toppings as designated by the pizza recipes that can be stored in a pizza franchise memory.

After all of the ingredients are placed on the dough, the dough holder can be removed from the pizza preparation station. The pizza can then be removed from the dough holder and placed in the pizza oven for baking. The pizza can be quickly cooked in the pizza oven. In some embodiments, the pizza will be cooked for a specific period of time at a specific temperature. In other embodiments, sensors can be placed in the pizza oven to detect the temperature, color, or other attribute of the pizza to determine if the pizza is properly cooked. The baked pizza can be removed from the oven and placed in a pizza box that can be given to the customer.

At 960, the franchisee transmits pickup information (e.g., to a driver who delivers the pizza or to the customer who will pick up the pizza).

At 970, the customer receive the pizza, eats the pizza, and optionally provides feedback through the app. The feedback can include both suggestions and personal preferences. At 980, the server computer analyzes and stores customer feedback. The feedback can be transmitted back to the server computer that can analyze the feedback of all customers. The processor of the server computer can match the feedback to the customer's orders and then make adjustments to the pizza making processes by addressing complaints or suggestions. The feedback can be analyzed based upon customer demographics such as age, location, etc. Based on the feedback, the processor can make customer specific adjustments to the recipes and cooking processes for the pizzas to hopefully improve the customer's pizza experience. The feedback data can also be used to make general changes to the pizza recipes and cooking processes that can be stored, distributed, and applied to pizzas ordered by new customers.

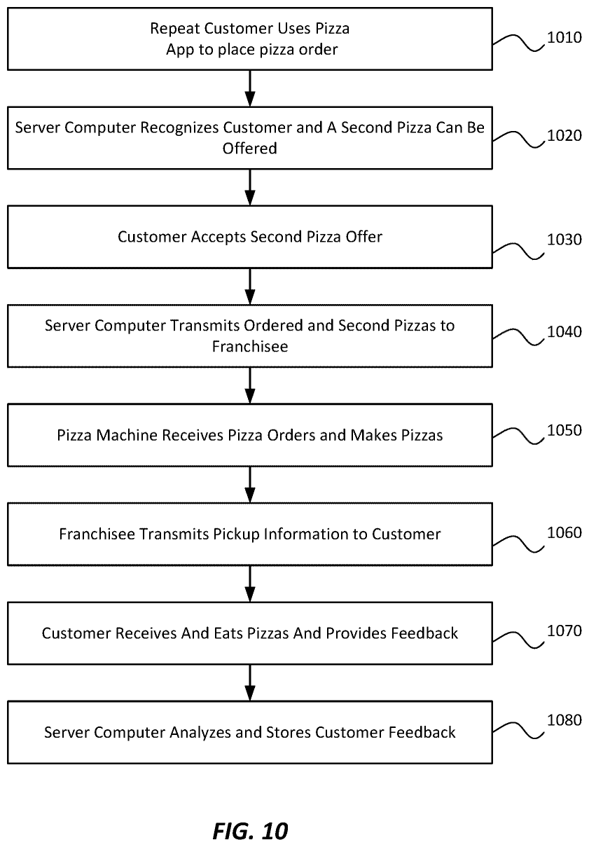

FIG. 10 is a flow diagram of method steps for processing pizza orders from repeat customers via a computing server according to some embodiments.

At 1010, a repeat customer can use an app on a computing device or a website for the pizza franchise to order a pizza. At 1020, the server computer recognizes the repeat customer and the server computer can offer the customer a second pizza. The second pizza offer can be based on the customer's feedback, past purchases, or the second pizza can be offered to all or random customers. The customer may opt into the second pizza program for all orders. In some embodiments, the second pizza can be offered in exchange for participation in the feedback or in exchange for good customer loyalty. For example, if a customer has provided more than a predetermined amount of feedback or more than a predetermined number of prior orders, the server computer can offer the second pizza to the customer free of charge. Some embodiments allow users to personalize their slice and future orders.

At 1030, the customer accepts the second pizza offer. If the second pizza offer is accepted, the acceptance can be transmitted to the server computer. The server computer can transmit the customer's ordered pizza and a second pizza to a pizza franchise. At 1050, a pizza machine receives the pizza order and makes the pizzas. In some embodiments, the processor of the pizza machine can make a second pizza recipe based upon predicted pizza preference information for the customer that can include the customer's own feedback, trends in preference feedback from other customers, and trends in feedback from customers who can have a similar age and location demographic.

At 1060, the franchisee transmits pickup information (e.g., to a driver who delivers the pizza or to the customer who will pick up the pizzas). At 1070, the customer receive the pizzas, eats the pizzas, and optionally provides feedback through the app. The feedback can include both suggestions and personal preferences. At 1080, the server computer analyzes and stores customer feedback. In some embodiments, the second pizza can be similar to the customer's pizza order but with one or more changes to the ingredients or cooking so that there are some easily noticeable differences between the pizzas. In FIG. 6B, a two-pizza box is illustrated having an “A” pizza and a “B” pizza. The customer can eat both pizzas and under each pizza there may be a QR code. The customer can scan the QR code of the favorite pizza and this favorite pizza information can be transmitted back to the server and stored with the customer's other pizza preference information. As discussed, this customer feedback information can be used to customize and improve the customer's future pizza recipes. The feedback data can be provided to a server computer and used to continually refine the desired tastes of the customers with improved pizzas. M ore specifically, the system can provide different combinations of ingredients on the pizzas and the customer can provide positive or negative feedback for each new pizza. Eventually after multiple iterations, the system can arrive at a “perfect” pizza for each customer. The perfect pizza data for the customers can be saved and stored by the pizza franchise server's system memory and/or the memory of the franchise processor. This stored data can allow the customer's current perfect pizza to be easily ordered and made in the future.

In some embodiments, the system can offer and provide second pizzas that are substantially different than a known customer's normal pizza order. In order to determine the alternative second pizza, the system can identify what are the current popular pizzas. This can be adjusted for demographics, location, and known customer likes/dislikes. The system can also determine trends in pizza toppings for different regions of the country or world and offer the top trending toppings as a second pizza. Also, new ingredients can be developed that the customer may want to taste. For example, plant based meat substitute toppings are available, so some customers may want to try meat substitutes such as vegan meats and cheeses. Other new pizza ingredient trends can include new pepper varieties (e.g., cherry and pasilla peppers), new pepperoni styles (e.g., char and old world), and Mexican inspired meats (e.g., chorizo, carne asada, BBQ pork, chicken, etc.). These new pizza ingredients can be offered as they are developed and become popular.

The described pizza machine can have various features that can further improve performance, cleaning, and automation. For example, the design of the pizza ingredient storage containers can improve efficiency, consistency, and freshness of the food items. The franchises can operate more efficiently and profitably, by simplifying and improving the operations of the pizza making equipment.

Non-liquid pizza topping containers can have augers or similar mechanisms that can be sized according to the ingredients' shape and size. Small toppings such as garlic and capers can have a substantially smaller auger mechanism compared to larger toppings such as pepperoni, peppers, and anchovies. The auger mechanism can also be different for flat ingredients such as baby spinach compared with larger chunky ingredients such as broccoli, tomatoes, and other large toppings. Each of these topping containers can have a different auger mechanism that will properly dispense the topping onto the pizza dough.

The non-liquid containers may not require liquid tight seals while the containers are being used with the pizza preparation station. However, during refrigerated storage, it can be desirable to seal the auger portion of the container. A sealing cap can be placed over the auger portion of the containers during refrigerated storage. In other embodiments, the containers can be placed on a storage shelf in the refrigeration unit that includes integrated cap couplings that provide gas or liquid seals for the container auger portions of the container assemblies.

Different ingredient containers can have different valve/auger mechanisms. The valve/auger mechanism can depend upon the type and size of the ingredient in the storage container. Liquids such as pizza sauces can have a liquid tight valve that can prevent the sauce liquids from leaking out of the storage containers when the sauce is not being placed on the dough. The sauces may also have a mechanism such as a peristaltic pump, paddle wheel, or auger that can assist in causing the sauce to flow onto the dough when actuated.

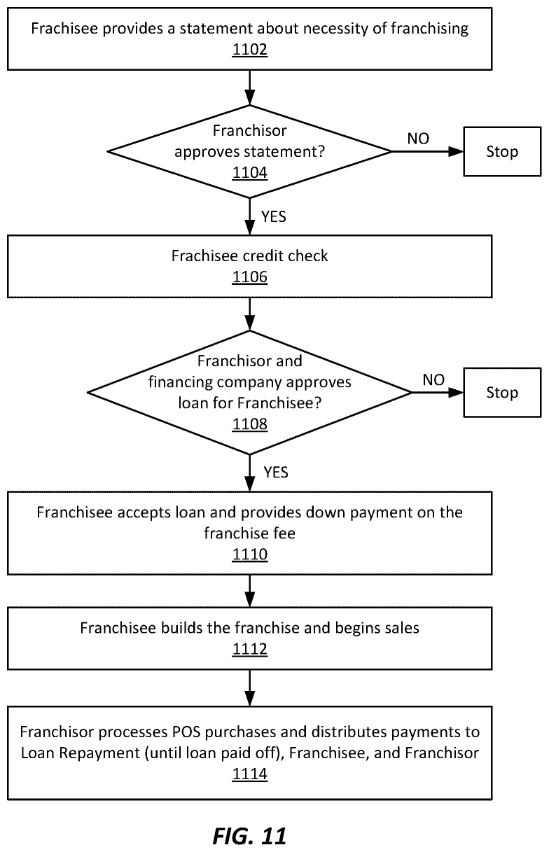

FIG. 11 is a flow diagram of method steps for managing pizza franchises through a computing server according to some embodiments.

In some embodiments, the described pizza making apparatus can be used as an integral part of a franchise business system. The franchiser and franchisee can have a business contract with an agreed upon division of revenues with the franchiser receiving a first percentage and the franchisee receiving a second percentage pizza sales revenue. The first percentage can be applied to the basic franchiser royalty payment and the second percentage can be the remainder that is earned by the franchisee. The first percentage and second percentage add up to 100%.

When pizzas are ordered, the payments for the pizza can be received by a payment system running on the server computer. The payment system can transmit the franchiser's first percentage portion of the pizza payment to the franchiser's bank account and the payment system can transmit the franchisee's second percentage portion of the payment to the franchisee's bank account.

The pizza ordering interface, the pizza preparation module or device and the pizza oven can be controlled with software running on a processor. In addition to providing the described functionality, system software can also be used to track the sales data for the pizzas prepared by the pizza machines and can receives payments for each of the pizzas sold. The tracked sales data can be used to detect pizza purchase volumes and predict future sales. The sales data can be used by the inventive system to identify various metrics such as pizza ingredient consumption rates. This can provide guidance for the franchisor to order pizza dough, sauce, cheese, and toppings so that the required pizza ingredients can always be on hand. The sales data can also make sales predictions for forecasting projected sales and revenue income. This information can be useful for understanding expansion options.

Since the disclosed system can be enabled by software that can track each slice sold, a franchise network server can be a pizza franchise and can be financed through the franchisee's pizza sales. This is totally unique as compared to traditional franchise models. The sales data obtained by the disclosed system can be used to identify franchisees that can be candidates for pizza making equipment financed through pizza sales. For example, the system can model and predict the revenue for the franchisee. The system can produce a report for the franchisee showing the predicted revenue based on the pizza making equipment and historical financial data for other franchisees. The system can use this information to create an equipment financing offer for the franchisee.

At 1102, a franchisee provides a statement about necessity of financing. If at 1104, the franchisor does not accept the statement, the method terminates. If at 1104, the franchisor does accept the statement, at 1106 the franchisor performs a credit check.

If at 1108, the franchisor and financing company do not approve the loan for the franchisee, the method terminates. If at 1108, the franchisor and financing company approve the loan for the franchisee, a loan is offered to the franchisee. At 1110, the franchisee accepts the loan and provides a down payment on the franchise fee. At 1112, the franchisee builds the franchise and begins sales. At 1114, the franchisor processes point-of-sale (POS) purchases and distributes payments to loan repayment (until the loan is paid off), the franchisee, and the franchisor.

In some embodiments, traditional loans can be used by franchisees for pizza equipment financing. However, in other embodiments, the financing offer can be based upon the sales revenues collected from the franchisee's pizza sales which can be substantially different than traditional loans. For example, in an embodiment, a pizza equipment purchasing agreement may specify that the franchisor will pay for the pizza making equipment from an additional X % of the collected revenues until the pizza making equipment is paid off with interest. The franchisor can review the report and either accept or reject the revenue financing offer. If the offer is accepted, the franchise payment system can automatically deduct the additional X % payments for the financed pizza making equipment from the revenues collected by the system from pizza sales. Because the payments are made from the pizza sales, the equipment payments are made in proportion to pizza sales revenues which can reduce the payments when sales revenues are lower than expected while increasing payments when sales are higher than expected. This inventive financing system creates new ways to market low cost franchises to the public. This franchise model has yet to be done by other companies.

The disclosed embodiments provide a unique franchise or multi-unit retail model that can utilize robotics and automation for more efficient and profitable food services. A barrier to entry into a franchise can be the costs required to start a franchise. The franchise model can be more cost efficient than traditional pizza franchises because it can be operated in very small spaces that can result in lower rent than existing larger pizza restaurants. In other embodiments, the inventive pizza making modules can be placed in a mobile vehicle and powered by electrical energy stored in batteries. These vehicles can be food trucks, vans, or any vehicle with sufficient space for the pizza making equipment. The pizzas can be made anywhere that is accessible by the vehicle. The small pizza making equipment only requires a small space which reduces operating costs and allows for easier mobility. The inventive system also only needs one person to operate the pizza making machines which can greatly simplify operations. For example, the pizza making system or a pizza oven can be in a moving delivery vehicle. The system can determine an estimated time of arrival at a customer's designated delivery location. The system can start baking the pizza at a time coordinated to finish cooking just before arrival at the delivery location.

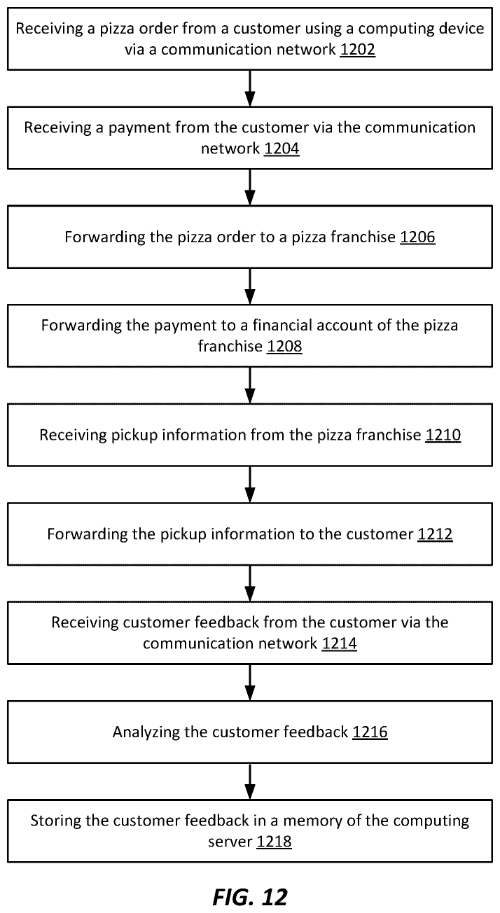

FIG. 12 is a flow diagram of method steps for processing pizza orders through a computing server according to some embodiments. At 1202, a computing server receives a pizza order from a customer using a computing device via a communication network. At 1204, the computing server receives a payment from the customer via the communication network. At 1206, the computing server forwards the pizza order to a pizza franchise. At 1208, the computing server forwards the payment to a financial account of the pizza franchise. The pizza is then made by a pizza making device. At 1210, the computing server receives pickup information from the pizza franchise. At 1212, the computing server forwards the pickup information to the customer. At 1214, the computing server receives customer feedback from the customer via the communication network. At 1216, the computing server analyzes the customer feedback. At 1218, the computing server stores the customer feedback in a memory of the computing server.

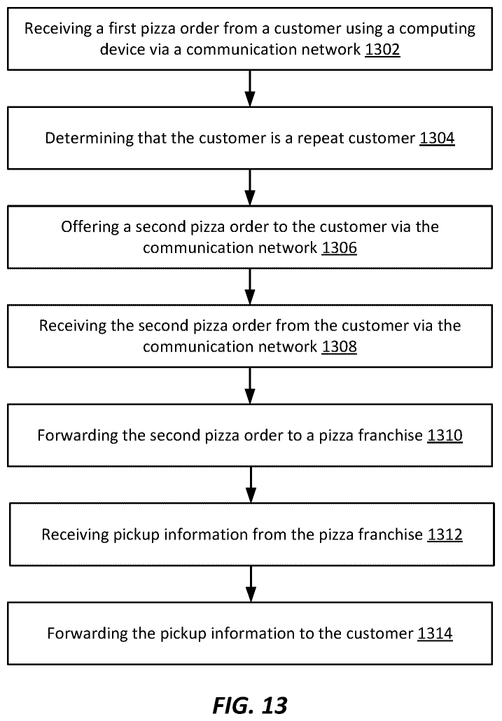

FIG. 13 is a flow diagram of method steps for processing pizza orders from repeat customers via a computing server according to some embodiments. At 1302, a computing server receives a first pizza order from a customer using a computing device via a communication network. At 1304, the computing server determines that the customer is a repeat customer. At 1306, the computing server offers a second pizza order to the customer via the communication network. At 1308, the computing server receives the second pizza order from the customer via the communication network. At 1310, the computing server forwards the second pizza order to a pizza franchise. The first pizza and second pizza are made by a pizza making device. At 1312, the computing server receives pickup information from the pizza franchise. At 1314, the computing server forwards the pickup information to the customer.

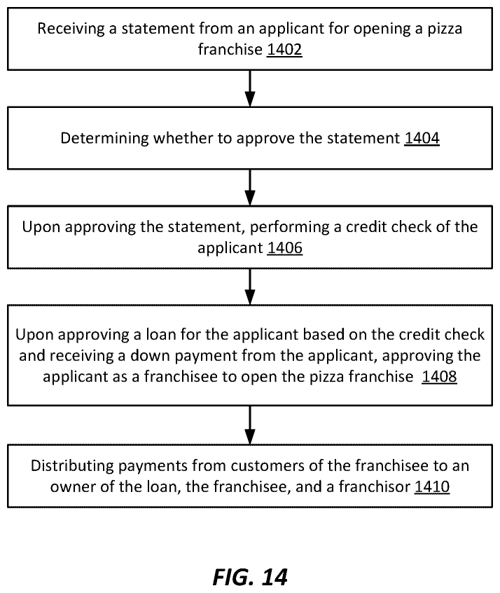

FIG. 14 is a flow diagram of method steps for managing pizza franchises through a computing server according to some embodiments. At 1402, a computing server receives a statement from an applicant for opening a pizza franchise. At 1404, the computing server determines whether to approve the statement. At 1406, upon approving the statement, the computing server performs a credit check of the applicant. At 1408, upon approving a loan for the applicant based on the credit check and receiving a down payment from the applicant, the computing server approves the applicant as a franchisee to open the pizza franchise. At 1410, the computing server distributes payments from customers of the franchisee to an owner of the loan, the franchisee, and a franchisor.

As described above, embodiments of this disclosure provide pizza ingredient dispensing devices that can have a compact design and can allow automated preparation of customized pizzas in a relatively small physical space. Embodiments of the present disclosure also provide pizza making apparatuses and pizza franchise systems using computing servers.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and “at least one” and similar referents in the context of describing the disclosure (especially in the context of the following claims) are to be construed to cover both the singular and the plural, unless otherwise indicated herein or clearly contradicted by context. The use of the term “at least one” followed by a list of one or more items (for example, “at least one of A and B”) is to be construed to mean one item selected from the listed items (A or B) or any combination of two or more of the listed items (A and B), unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein.

All methods described herein can be performed in any suitable order unless otherwise indicated herein or otherwise clearly contradicted by context. The use of any and all examples, or exemplary language (e.g., “such as”) provided herein, is intended merely to better illuminate the disclosure and does not pose a limitation on the scope of the disclosure unless otherwise claimed. No language in the specification should be construed as indicating any non-claimed element as essential to the practice of the disclosure.

Preferred embodiments of this disclosure are described herein. Variations of those preferred embodiments may become apparent to those of ordinary skill in the art upon reading the foregoing description. The inventors expect skilled artisans to employ such variations as appropriate, and the inventors intend for the disclosure to be practiced otherwise than as specifically described herein. Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein or otherwise clearly contradicted by context.

It should be understood that the original applicant herein determines which technologies to use and/or productize based on their usefulness and relevance in a constantly evolving field, and what is best for it and its players and users. Accordingly, it may be the case that the systems and methods described herein have not yet been and/or will not later be used and/or productized by the original applicant. It should also be understood that implementation and use, if any, by the original applicant, of the systems and methods described herein are performed in accordance with its privacy policies. These policies are intended to respect and prioritize player privacy, and are believed to meet or exceed government and legal requirements of respective jurisdictions. To the extent that such an implementation or use of these systems and methods enables or requires processing of user personal information, such processing is performed (i) as outlined in the privacy policies; (ii) pursuant to a valid legal mechanism, including but not limited to providing adequate notice or where required, obtaining the consent of the respective user; and (iii) in accordance with the player or user's privacy settings or preferences. It should also be understood that the original applicant intends that the systems and methods described herein, if implemented or used by other entities, be in compliance with privacy policies and practices that are consistent with its objective to respect players and user privacy.

What is claimed is:

1. A pizza ingredient dispensing device for dispensing sauces and toppings on a pizza dough, the pizza ingredient dispensing device comprising:
a pizza tray movement stage configured to hold and move a pizza tray, the pizza tray for receiving and hold the pizza dough;
a plurality of containers positioned above the pizza tray movement stage, each respective container comprising a storage compartment for storing a respective ingredient, and a valve for dispensing the respective ingredient through an outlet;
a first motor mounted on a carriage;
an actuator coupled to the first motor, the actuator configured to be engaged with the valve of each container, wherein the first motor is configured for actuating the actuator when the actuator is engaged with the valve of a respective container in order to dispense the respective ingredient;
a second motor for moving the carriage so as to engage the actuator with the valve of a respective container; and
a processor communicatively coupled with the pizza tray movement stage, the first motor, and the second motor, the processor configured to:
control the second motor so as to engage the actuator sequentially with the valves of one or more containers for selected ingredients according to a pizza order;
control the first motor so as to dispense the selected ingredients from the one or more containers onto the pizza dough; and
control the pizza tray movement stage to move the pizza tray in coordination with the controlling of the first motor and the second motor, so that the selected ingredients are dispensed evenly on the pizza dough.

2. The pizza ingredient dispensing device of claim 1, wherein the valve comprises a blade slot, the actuator comprises a blade shaft configured to be inserted into the blade slot, and the first motor is configured to rotate the blade shaft so as to rotate the valve in order to dispense the respective ingredient.

3. The pizza ingredient dispensing device of claim 2, wherein the plurality of containers is positioned next to each other in a row so that the blade slots of the plurality of containers is aligned with respect to each other, and the second motor is configured to move the carriage along a track so that the blade shaft is capable of being moved through the blade slots.

4. The pizza ingredient dispensing device of claim 1, wherein the pizza tray comprises a magnetic disc, the pizza tray movement stage comprises a magnetic coupling conveyer configured to hold the pizza tray via a magnetic force.

5. The pizza ingredient dispensing device of claim 1, wherein the pizza tray comprises a non-sticking coating on a top surface thereof, on which the pizza dough is placed.

6. The pizza ingredient dispensing device of claim 1, wherein the pizza tray comprises a coating on a bottom surface thereof, thereby creating a sliding surface with respect to the magnetic coupling conveyer.

7. The pizza ingredient dispensing device of claim 1, wherein the pizza tray movement stage comprises a third motor for moving the pizza tray along an x-axis, and a fourth motor for moving the pizza tray along a y-axis perpendicular to the x-axis.

8. The pizza ingredient dispensing device of claim 7, wherein the pizza tray movement stage is configured to move the pizza tray in a serpentine pattern as a respective ingredient is being dispensed from a respective container.

9. The pizza ingredient dispensing device of claim 7, wherein the pizza tray movement stage comprises a fifth motor for rotating the pizza tray.

10. The pizza ingredient dispensing device of claim 9, wherein the pizza tray movement stage is configured to move the pizza tray in a circular pattern or a spiral pattern as a respective ingredient is being dispensed from a respective container.

11. The pizza ingredient dispensing device of claim 1, wherein each respective container is removably positioned in a respective receptacle, so that the respective container is capable of being removed for refilling of the respective ingredient or being replaced by another container already filled with the respective ingredient.

12. A pizza making apparatus comprising:
one or more pizza ingredient dispensing devices of claim 1; and
an oven for baking the pizza dough with the selected ingredients placed thereon.

13. The pizza making apparatus of claim 12, further comprising at least one robotic arm for placing the pizza tray or removing the pizza tray from the pizza tray movement stage, and for placing the pizza tray into or removed from the oven.

14. The pizza making apparatus of claim 12, further comprising one or more sensors positioned inside the oven, the one or more sensors for monitoring a temperature of the pizza dough while the pizza dough is being baked.

15. The pizza making apparatus of claim 12, wherein the one or more sensors comprise a temperature sensor, a camera, and/or a weight sensor.

16. The pizza making apparatus of claim 12, further comprising a transceiver for receiving the pizza order from a computer server.

17. A method of processing pizza orders through a computing server, the method comprising:
receiving a pizza order from a customer using a computing device via a communication network;
receiving a payment from the customer via the communication network;
forwarding the pizza order to a pizza franchise;
forwarding the payment to a financial account of the pizza franchise;
receiving pickup information from the pizza franchise; and
forwarding the pickup information to the customer.

18. The method of claim 17, further comprising:
receiving customer feedback from the customer via the communication network;
analyzing the customer feedback; and
storing the customer feedback in a memory of the computing server.

19. The method of claim 17, further comprising:
receiving a first pizza order from the customer using the computing device via the communication network;
determining that the customer is a repeat customer;
offering a second pizza order to the customer via the communication network;
receiving the second pizza order from the customer via the communication network;
forwarding the second pizza order to a pizza franchise;
receiving pickup information from the pizza franchise; and
forwarding the pickup information to the customer.

20. A method for managing pizza franchises through a computing server, the method comprising:
receiving a statement from an applicant for opening a pizza franchise;
determining whether to approve the statement;
upon approving the statement, performing a credit check of the applicant;
upon approving a loan for the applicant based on the credit check and receiving a down payment from the applicant, approving the applicant as a franchisee to open the pizza franchise; and
distributing payments from customers of the franchisee to an owner of the loan, the franchisee, and a franchisor.
